(19) United States
(12) Patent Application Publication
(10) Pub. No.: US 2011/0118856 A1
(43) Pub. Date: May 19, 2011

(54) HEATER AND MOTOR CONTROL

(76) Inventor: Mark J. Brudevold, Fridley, MN (US)

(21) Appl. No.: 13/001,899

(22) PCT Filed: Jun. 22, 2009
(86) PCT No.: PCT/US09/48103

§ 371 Date: Dec. 29, 2010

Related U.S. Application Data
(62) Division of application No. 61/077,663, filed on Jul. 2, 2008.

(51) Int. Cl. G05B 13/02

(52) U.S. Cl. 700/43

(57) ABSTRACT

The control method uses the following scheme: Control Value (CV)=Proportional Value (PV)+Derivative Value (DV)+Derivative Correction (DC), where PV goes from 0 to MAX and operates over a very narrow band—in a temperature control example plus or minus 1 degree C. from the setpoint and is used to stabilize CV and enforce the setpoint. DV goes from −MAX to MAX and is exponentially decayed over a time constant to weigh the most recent values heavier than older values. This allows the control to see the real derivative despite a large step size which might otherwise mask it and within a small time window. DC goes from −MAX to MAX and makes this scheme work for any situation. The desired derivative is defined based on the graph. This then adjusts to compensate when the slope is not following the ideal definition.

### TECHNICAL FIELD

This application claims the benefit of U.S. Application Ser. No. 61/077,663, filed Jul. 2, 2008, the contents of which are hereby incorporated by reference.

### BACKGROUND ART

Various methods of control have been used to control motors, heater and the like. While most are generally effective, they all have their own quirks and deficiencies.

The most basic form of control is on/off. Under this control strategy, heat is turned fully on when the temperature is below the setpoint and fully on when the temperature is above the setpoint. This technique is limited in how well it controls temperature, particularly with fast temperature changes, because there is no prevention of overshoots and undershoots due to the momentum of the heater.

On/off control is used in situations where there is no software (i.e. basic thermostats), very limited software, or the hardware is unable pulse a duty cycle over a short period of time. Older microwaves, for example, use an on/off technique with relays based on the power setting provided by the user.

Proportional-integral-derivative control (PID) is what usually comes to mind when thinking of control systems. This is an extremely popular general-purpose form of control that incorporates a means of controlling slope and center value. PID is simple to set up and very intuitive.

PID control uses three separate values to create a “control value”, which represents the percentage of available power to be applied to the load. These terms are the proportional value, integral value, and derivative value.

The proportional value is set by the distance from the measured temperature to the setpoint (the “error”), multiplied by a constant. This value has no memory of past measurements and is used to make adjustments to the control value upon changes in measurement. These adjustments are made immediately upon new measurements, before the integral value has time to react.

The integral value is a summation of the error value over time, multiplied by a constant. This term is what forces the temperature to the setpoint.

The derivative value is the rate of temperature change, multiplied by a constant. As the name implies, the purpose of this value is to limit the rate of change.

The primary purpose of explaining the above terms is so the weakness of PID control can be exposed. Notice that each of the three values is created using fixed constants. The effectiveness of PID control is sensitive to whether these constants are properly selected, and this depends on the system being controlled. Any time a system is operated in a different way, such as heating a different material or dispensing at a different flow rate, the values are no longer optimal and may result in poor regulation of temperature. The end result is that a truly versatile system is not possible with fixed PID control. Advanced PID control requires the addition of auto-tuning.

### DISCLOSURE OF THE INVENTION

The control method of the instant invention uses the following scheme:

Control Value(CV)=Proportional Value(PV)+Derivative Value(DV)+Derivative Correction(DC)

Where PV goes from 0 to MAX and operates over a very narrow band—in a temperature control example plus or minus 1 degree C. from the setpoint and is used to stabilize CV and enforce the setpoint. DV goes from −MAX to MAX and is exponentially decayed over a time constant to weigh the most recent values much heavier than older values. This allows the control to see the real derivative despite a large step size which might otherwise mask it and all within a small time window. DC goes from −MAX to MAX and makes this scheme work for any situation. The desired derivative is defined based on the graph. This then adjusts to compensate when the slope is not following the ideal definition. Averaging for this is different from DV and occupies a broader time range.

Scaling of PV, DV and DC with respect to each other is important.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIGS. 1 and 2 show how the proportional band evolves for scenarios with different power level requirements.

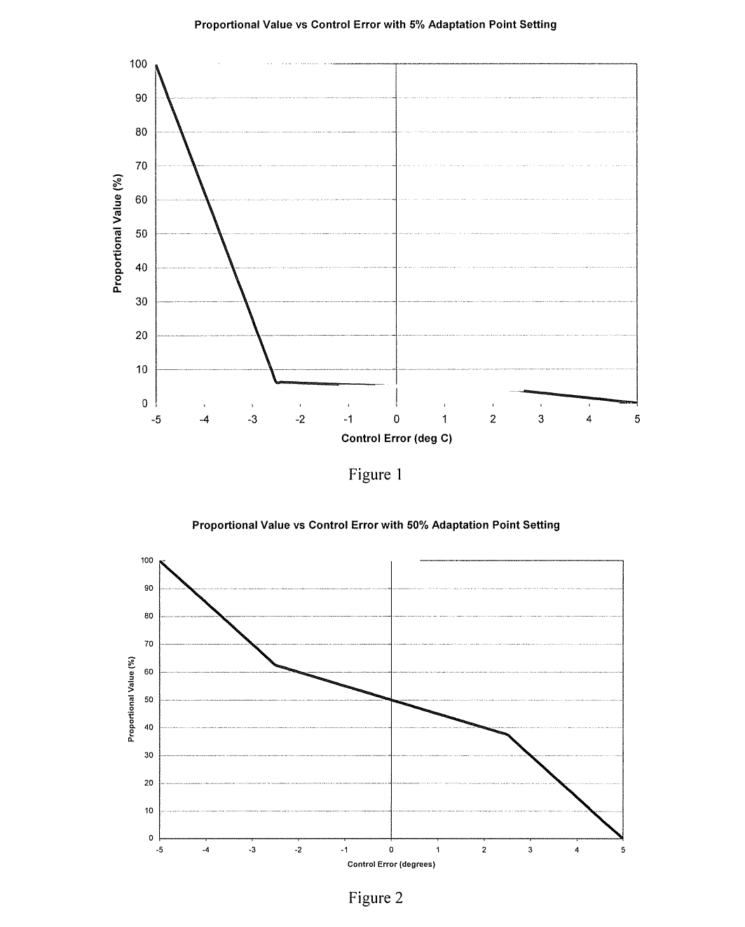

FIG. 3 shows the responses that can occur with a fixed derivative constant.

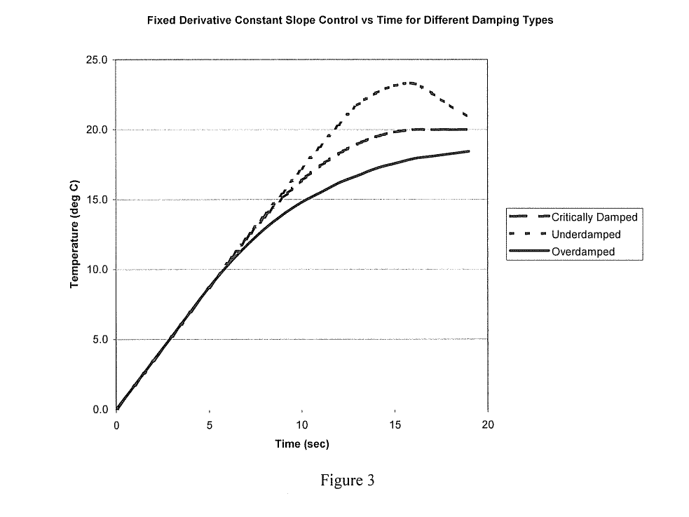

### BEST MODE FOR CARRYING OUT THE INVENTION

Adaptive control techniques were invented for the Temperature Control Modules to provide a platform that can control any heater in the various setups it may see in the field. The limitations of PID control are overcome by taking a different approach to temperature control.

In creating the control algorithm, it was noted that temperature control can be broken into two crucial aspects: control of slope to reach the setpoint, and steady state control after the setpoint is reached. These can be treated somewhat independently of each other, particularly for very slow systems such as Graco's THERM-O-FLOW platen. The control algorithm needed to address this fact in order to be successful.

The integral term is problematic in controls and can really be considered the equivalent of a band-aid because it is a summation of past errors. The problem with the integral term is that it has a tendency to create oscillations in the control by adding up to a value that is too large when the temperature is below the setpoint and vice versa when above the setpoint. These oscillations are why PID algorithms need to be tuned, to balance the PID constants in an attempt to minimize oscillations. This balancing is also the reason why PID control can cause poor regulation when the system is altered.

The purpose of the integral value is to provide a means for forcing the temperature to the setpoint, and that facility is obviously necessary. A unique solution was devised. The proportional band is extremely nice because the control value automatically modulates as the measurement changes, without a long delay for integration to occur. What was needed was a way to properly place the proportional band such that the integral term is no longer needed.

The solution that occurred after many varying attempts to solve this challenging problem, was to use the present control value, which is a combination of proportional and derivative values, to adapt the proportional band. The details surrounding how this is done are intricate, but essentially the proportional band moves up when the control value exceeds the middle of the proportional band and down when the control value is less than the middle of the proportional band. As a result, the proportional band is precisely in place by the time the heater is up to temperature and adapts on-the-fly as needed when the system changes (i.e. a proportioner goes from inactive to spraying foam). With the creation of this adapting proportional band, the integral term was able to be eliminated.

There are several features of the proportional band in addition to adaptation. The band is not linear from full value to zero value; instead, the size of the band is normalized based on the mid-point that has been selected through adaptation. This way, a heater nominally requiring 5% duty cycle may see step sizes of 0.5% in the proportional band, whereas a heater requiring 50% may see step sizes of 5%. Normalization is valuable for tight control at low flow rates. See the example charts below, showing how the proportional band evolves for scenarios with different power level requirements. These two bands highlight the adaptive ability of the proportional band because no change was necessary in the configuration settings between the two cases.

Notice in the graphs that the proportional band is scaled in two ways. The first is within the proportional bounds based on the specified step percentage. The second is between the edges of the proportional band and the control band, where scaling is applied linearly from the proportional value at the edge of the band to full value at the edge of the control band. This provides a normalized, high resolution control value within the proportional band and a configurable wall that combines with the derivative value to fight sudden shifts of temperature outside the proportional band.

Advancements were also made for derivative control. The typical idea behind the derivative value is to keep temperature changes slow enough to keep overshoots and undershoots from occurring. A different approach from the norm was taken here, instead defining a desired slope based on proximity to the setpoint and using the derivative value to achieve it.

The chart below shows the responses that can occur with a fixed derivative constant. The underdamped case comes as a result of the control value not ramping back fast enough, while the overdamped case is a slow heating time resulting from the control value ramping back more than necessary. For a pumping application, low flow rates would create an underdamped situation and high flow rates would create an overdamped situation. Only medium flow rates would see optimal control, which is lightly underdamped so the temperature rises quickly but does not overshoot significantly.

Without adaptive slope control, a conservative approach using heavy underdamping is the only way to prevent overshoots and undershoots. Heating times are correspondingly much slower than they are capable of being.

This new method of adaptive slope control can create any type of damping and enforce that parameter over the entire range of applications a particular heater may see because the control output is based on the desired slope. Selection of different values for the desired slope allows the user to configure their system based on tradeoffs between response time and controllability. The fundamental term used to create the desired slope is an adapting resistance term. The algorithm constantly revises the resistance term using a multi-faceted calculation.

As with most aspects of this control algorithm, adaptation is not linear. It is exponential instead. Near the setpoint, a special trick involving the exponential aspect of the derivative resistance adaptation is employed that causes the derivative term to essentially hibernate until a temperature change in one direction is seen. This makes the derivative relatively inactive when in steady state, where the proportional value needs to be the primary contributor to the control value. Acceleration out of hibernation is configurable and can be extremely quick (less than a second) for systems that need rapid response or very slow for systems that do not need slope control once the setpoint is reached.

The control method of the instant invention uses the following scheme:

Control Value(CV)=Proportional Value(PV)+Derivative Value(DV)+Derivative Correction(DC),
PV goes from 0 to MAX and operates over a very narrow band—in a temperature control example plus or minus 1 degree C. from the setpoint and is used to stabilize CV and enforce the setpoint.
DV goes from −MAX to MAX and is exponentially decayed over a time constant to weigh the most recent values much heavier than older values. This allows the control to see the real derivative despite a large step size which might otherwise mask it and all within a small time window.
DC goes from −MAX to MAX and makes this scheme work for any situation. The desired derivative is defined based on the graph. This then adjusts to compensate when the slope is not following the ideal definition. Averaging for this is different from DV and occupies a broader time range.

Adaptive control techniques provide a platform that can control any heater in the various setups it may see in the field. The limitations of PID control are overcome by taking a different approach to temperature control.

In creating the control algorithm, it was noted that temperature control can be broken into two crucial aspects: control of slope to reach the setpoint, and steady state control after the setpoint is reached. These can be treated somewhat independently of each other, particularly for very slow systems such as Graco's THERM-O-FLOW® Platen. The control algorithm needed to address this fact in order to be successful.

The integral term is problematic in controls and can really be considered the equivalent of a band-aid because it is a summation of past errors. The problem with the integral term is that it has a tendency to create oscillations in the control by adding up to a value that is too large when the temperature is below the setpoint and vice versa when above the setpoint. These oscillations are why PID algorithms need to be tuned, to balance the PID constants in an attempt to minimize oscillations. This balancing is also the reason why PID control can cause poor regulation when the system is altered.

The purpose of the integral value is to provide a means for forcing the temperature to the setpoint, and that facility is obviously necessary. A unique solution was devised. The proportional band is extremely nice because the control value automatically modulates as the measurement changes, without a long delay for integration to occur. What was needed was a way to properly place the proportional band such that the integral term is no longer needed.

The invention is to use the present control value, which is a combination of proportional and derivative values, to adapt the proportional band. The details surrounding how this is done are intricate, but essentially the proportional band moves up when the control value exceeds the middle of the proportional band and down when the control value is less than the middle of the proportional band. As a result, the proportional band is precisely in place by the time the heater is up to temperature and adapts on-the-fly as needed when the system changes (i.e. proportioner goes from inactive to spraying foam). With the creation of this adapting proportional band, the integral term was able to be eliminated.

There are several features of the proportional band in addition to adaptation. The band is not linear from full value to no value; instead, the size of the band is normalized based on the mid-point that has been selected through adaptation. This way, a heater nominally requiring 5% duty cycle may see step sizes of 0.5% in the proportional band, whereas a heater requiring 50% may see step sizes of 5%. Normalization is valuable for tight control at low flow rates.

The proportional band is also scaled in two ways. The first is within the proportional bounds based on the specified step percentage. The second is between the edges of the proportional band and the control band, where scaling is applied linearly from the proportional value at the edge of the band to full value at the edge of the control band. This provides a normalized, high resolution control value within the proportional band and a brick wall that combines with the derivative value to fight sudden shifts of temperature outside the proportional band.

Advancements were also made for derivative control. The typical idea behind the derivative value is to keep temperature changes slow enough to keep overshoots and undershoots from occurring. A different approach from the norm was taken here, instead defining a desired slope based on proximity to the setpoint and using the derivative value to achieve it.

Creating the desired slope is difficult and is done using an adapting resistance term. As with most aspects of the control algorithm, adaptation is not linear. It is exponential instead. Near the setpoint, a special trick involving the exponential aspect of the derivative resistance adaptation is employed that causes the derivative term to essentially hibernate until a temperature change in one direction is seen. This makes the derivative relatively inactive when in steady state, where the proportional value needs to be the primary contributor to the control value. Acceleration out of hibernation is configurable and can be extremely quick (less than a second) for systems that need rapid response or very slow for systems that do not need slope control once the setpoint is reached.

Configurable settings are available to enable an end group to optimize control of their system. Three of these configurations are critical, while the others are provided to make the system fully configurable and should not require much fine-tuning from the default values. A wide range of values should work for any system because the algorithm is extremely stable—the key is to be in the right general ballpark. The primary values that need to be set are the time constants, which tell software how fast the system is expected to change and how quickly to react.

The following are critical settings:

Desired Slope
Specifies the profile desired from the heater as it comes up to temperature.
The derivative value is responsible for enforcing the desired slope. The desired slope value available for setting is the constant between the control bounds and proportional bounds, which then trails off linearly between the proportional bounds and the setpoint to create a soft arrival at the setpoint.

Derivative Adaptation Period
Specifies the speed of response to slopes deviating from the desired slope parameter
This value should be set similar to the proportional band adaptation period
Slow systems will want this term to be at least 10 seconds
Fast systems will want to keep this term in single digit seconds

Proportional Band Adaptation Period
In order to eliminate oscillations in steady state, the adaptation period is available for configuration. This setting allows groups to completely eliminate the ripple in the temperature control.
A wide range of periods will work for a given system. The key is to make the period long enough to eliminate ripples but short enough to react to changes in the system
The easiest way to set this value is to choose a relatively small number and then watch the oscillations in temperature control. These should be somewhat sinusoidal. If the oscillation period recurs every 30 seconds, a value of at least 30 seconds is sufficient to eliminate oscillations. The biggest factor in the oscillation is the amount of time between the application of heat and the change in heat arriving at the RTD. Systems with poorly placed RTDs will need a long time period in order to eliminate oscillations.

The following additional settings are available:

Control Range
Sets the relative temperature range from the setpoint in which the control algorithm is active
If the temperature is greater than the upper bound, the control output is set to zero
If the temperature is below the lower bound, the control output is set to the maximum value
The proportional value scales linearly between the edge of the proportional bounds and the control bounds

Proportional Bounds
Determine the range in which the “proportional contribution per degree” is in effect

Proportional Contribution Percentage Per Degree
Within the proportional band, the proportional part of the control value is set using the value at the setpoint plus the distance from the setpoint times a step size of this configured percentage. For example, when the center point of the proportional band has adapted to 20% duty cycle, a setting of 5% per 0.1° C. would yield 10% duty cycle one degree above the setpoint and 30% duty cycle one degree below the setpoint.
This value is not critical to good control but is a useful setting to have available. Systems with slow heating times and very close control are better off choosing a small value for the percentage change per degree (i.e. 2%), while faster systems will want to use a larger percentage (i.e. 5%).

Derivative Mode—two options are available for the derivative mode
LIMIT_PROPORTIONAL_VALUE
   Control value is determined by the proportional value
   Derivative value is used to limit the maximum control value
   This is the best option for controlling slow systems
ADD_TO_PROPORTIONAL_VALUE
   Control value is determined by the proportional value plus the derivative value
   This is the best option for controlling fast systems

Derivative Time Constant
Selects the period over which the derivative is determined
Fast systems need a short time constant in order to react quickly to temperature changes (i.e. 0.5 seconds)
Slow systems will want to use a longer time period because the temperature change is small enough that several seconds are needed in order to register an accurate slope

Derivative Contribution Limits
The maximum amount of the derivative contribution can be limited on both the negative and positive sides
This is available primarily for testing purposes, but it some groups may want to limit the strength of the derivative term

Proportional Contribution
The proportional value can only be positive, and the ability to limit its maximum value is provided, mostly for testing purposes.

Derivative Resistance
Maximum and minimum derivative resistance values can be configured. Software adaptively creates its own limits, but they are available nonetheless in case any group finds a need to further limit them.

Derivative Adaptation Acceleration
The derivative resistance is able to adapt extremely quickly when substantial temperature changes are seen but adapt slower when the changes are not that large. This is because acceleration is available. Setting this value to 10, for example, allows nearly instantaneous response to gun triggering for Reactor while keeping the derivative term from interfering with steady state control. Tanks do not need accelerated adaptation, so a value much closer to 1 is desirable.

Adaptive control techniques provide a platform that can control any heater or other electrical device in the various setups it may see in the field. The limitations of PID control are overcome by taking a different approach to temperature control.

In creating the control algorithm, it was noted that temperature control can be broken into two crucial aspects: control of slope to reach the setpoint, and steady state control after the setpoint is reached. These can be treated somewhat independently of each other, particularly for very slow systems. The control algorithm needed to address this fact in order to be successful.

The integral term is problematic in controls and can really be considered the equivalent of a band-aid because it is a summation of past errors. The problem with the integral term is that it has a tendency to create oscillations in the control by adding up to a value that is too large when the temperature is below the setpoint and vice versa when above the setpoint. These oscillations are why PID algorithms need to be tuned, to balance the PID constants in an attempt to minimize oscillations. This balancing is also the reason why PID control can cause poor regulation when the system is altered.

Desired Slope
Specifies the profile desired from the heater as it comes up to temperature.
The derivative value is responsible for enforcing the desired slope. The desired slope value available for setting is the constant between the control bounds and proportional bounds, which then trails off linearly between the proportional bounds and the setpoint to create a soft arrival at the setpoint.

Derivative Adaptation Period
Specifies the speed of response to slopes deviating from the desired slope parameter
This value should be set similar to the proportional band adaptation period
Slow systems will want this term to be at least 10 seconds
Fast systems will want to keep this term in single digit seconds

Proportional Band Adaptation Period
In order to eliminate oscillations in steady state, the adaptation period is available for configuration. This setting allows groups to completely eliminate the ripple in the temperature control.
A wide range of periods will work for a given system. The key is to make the period long enough to eliminate ripples but short enough to react to changes in the system
The easiest way to set this value is to choose a relatively small number and then watch the oscillations in temperature control. These should be somewhat sinusoidal. If the oscillation period recurs every 30 seconds, a value of at least 30 seconds is sufficient to eliminate oscillations. The biggest factor in the oscillation is the amount of time between the application of heat and the change in heat arriving at the RTD. Systems with poorly placed RTDs will need a long time period in order to eliminate oscillations.

Additional Settings Available

Control Range
Sets the relative temperature range from the setpoint in which the control algorithm is active
If the temperature is greater than the upper bound, the control output is set to zero
If the temperature is below the lower bound, the control output is set to the maximum value
The proportional value scales linearly between the edge of the proportional bounds and the control bounds

Proportional Bounds
Determine the range in which the “proportional contribution per degree” is in effect

Proportional Contribution Percentage Per Degree
Within the proportional band, the proportional part of the control value is set using the value at the setpoint plus the distance from the setpoint times a step size of this configured percentage. For example, when the center point of the proportional band has adapted to 20% duty cycle, a setting of 5% per 0.1° C. would yield 10% duty cycle one degree above the setpoint and 30% duty cycle one degree below the setpoint.
This value is not critical to good control but is a useful setting to have available.

Systems with slow heating times and very close control are better off choosing a small value for the percentage change per degree (i.e. 2%), while faster systems will want to use a larger percentage (i.e. 5%).

Derivative Mode
Two options are available for the derivative mode
   LIMIT_PROPORTIONAL_VALUE
      Control value is determined by the proportional value
      Derivative value is used to limit the maximum control value
      This is the best option for controlling slow systems
   ADD_TO_PROPORTIONAL_VALUE
      Control value is determined by the proportional value plus the derivative value
      This is the best option for controlling fast systems

Derivative Time Constant
Selects the period over which the derivative is determined
Fast systems need a short time constant in order to react quickly to temperature changes (i.e. 0.5 seconds)
Slow systems will want to use a longer time period because the temperature change is small enough that several seconds are needed in order to register accurate slope

Derivative Contribution Limits
The maximum amount of the derivative contribution can be limited on both negative and positive sides
This is available primarily for testing purposes, but some groups may want limit the strength of the derivative term

Proportional Contribution
The proportional value can only be positive, and the ability to limit its maximum value is provided, mostly for testing purposes.

Derivative Resistance
Maximum and minimum derivative resistance values can be configured. Software adaptively creates its own limits, but they are available nonetheless in case any group finds a need to further limit them.

Derivative Adaptation Acceleration
The derivative resistance is able to adapt extremely quickly when substantial temperature changes are seen but adapt slower when the changes are not that large. This is because acceleration is available. Setting this value to 10, for example, allows nearly instantaneous response to gun triggering for in a spray foam applicator keeping the derivative term from interfering with steady state control. Tanks do not need accelerated adaptation, so a value much closer to 1 is desirable.

It is contemplated that various changes and modifications may be made to the control without departing from the spirit and scope of the invention as defined by the following claims.

1. A method of controlling an electrical device by generating a control value to achieve a setpoint, said method comprising the steps of:
generating a proportional value (PV) range having a center, a minimum and a maximum and where said PV is such that the average of prior control values represents said center of said PV range and said PV minimum and said PV maximum are resealed over time to reflect response of said device;
generating a derivative value (DV) reflecting change over time and which weighs the most recent values more heavily than older values;
generating a derivative correction (DC) representing the desired slope of response; and
adding PV, DV and DC to generate a control value and applying said control value to said electrical device.

2. The method of claim 1 wherein said electrical device is a heater.

3. The method of claim 1 wherein said electrical device is a motor.
